(19) United States
(12) Patent Application Publication
(10) Pub. No.: US 2008/0223109 A1
(43) Pub. Date: Sep. 18, 2008

(54) Gas Concentration Measuring Method, Program and Apparatus With Determination of Erroneous Detection

(76) Inventors: Satoshi NITTA, Kameoka-shi (JP); Yoshihiro Osawa, Moriyama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/049,106

(22) Filed: Mar. 14, 2008

(30) Foreign Application Priority Data
Mar. 15, 2007 (JP) 2007-066854

(51) Int. Cl. G01N 7/00

(52) U.S. Cl. 73/23.2

(57) ABSTRACT

In a wave number region of measurement of a gas to be measured, an absorbance of the gas is found to calculate a concentration thereof, and the concentration is compared with a threshold value (FIG. 3; S8). When the concentration exceeds the threshold value, an absorbance of an interference-component gas is found to calculate a concentration thereof in a wave number region of measurement of the interference-component gas (S9). The concentration of the interference-component gas is compared with a threshold value of the concentration of the interference-component gas (S10) to generate information indicating that the concentration of the gas to be measured is high when the concentration of the interference-component gas is within the threshold value (S11).

### BACKGROUND OF THE INVENTION

1. Field of the Invention

The present invention relates to measurement of the concentration of a gas to be measured included in a sample gas.

2. Description of Related Art

A conventionally known gas concentration measuring method will be briefly described. First, the spectrum of light transmitted by a gas having no absorption in a certain wave number region (referred to as a background gas) is acquired to find an integration value B of the amount of the light in the wave number region. Then, the spectrum of light transmitted by a gas to be measured is acquired to find an integration value S of the amount of the light in the wave number region.

The absorbance Abs(S) of the gas to be measured is found using the amount B of the transmitted light by the background gas and the amount S of the transmitted light by the gas to be measured. The absorbance Abs(S) is found by the following equation:

Abs(S)=−log(S/B)

When the absorbance is thus calculated, the absorbance is calculated using the amount of light obtained by background measurement, so that the effect of a measuring apparatus can be offset.

The concentration of the gas to be measured is found using a calibration curve for defining the relationship between the absorbance and gas concentrations. Here, the calibration curve means reference data created using a sample gas whose concentration is found and the absorbance thereof, and is stored in an analyzing computer within a measuring and analyzing apparatus. In order to find the calibration curve, the concentration of the sample gas is changed to measure the absorbance of the gas to be measured. The concentration of the sample gas is used to enter the horizontal axis, and the area of an absorption peak is used to enter the vertical axis. Measurement points are plotted to determine the shape of the curve using a least-square method.

It is required that the concentration of the gas to be measured is accurately found in a multicomponent mixed gas that is a mixture of the gas to be measured and another gas (referred to as an interference-component gas) whose wave number region of absorption is overlapped with that of the gas to be measured.

Japanese Unexamined Patent Publication No. JP 2003-14625 A discloses a method for acquiring an absorbance spectrum of an exhaust gas in which a composition ratio of SO₃ and NH₃ is changed in a concentration meter for ultraviolet-absorbing and analyzing SO₃ and NH₃ in the exhaust gas, creating a calibration curve of SO₃ and NH₃ by multivariate analysis on the basis of absorbance spectrum data, and ultraviolet-absorbing and analyzing the exhaust gas introduced into a gas cell 17 on the basis of the calibration curve to simultaneously measure the concentrations of SO₃ and NH₃ in the exhaust gas. Japanese Unexamined Patent Publication No. JP 2005-291704 A and Japanese Unexamined Patent Publication No. JP 2003-57178 A similarly disclose methods of multivariate analysis.

In the methods of multivariate analysis, however, a calculation method becomes very complicated. The higher the concentration of the interference-component gas becomes, the more easily a concentration measurement error occurs. Therefore, erroneous determination and data output occur.

### SUMMARY OF THE INVENTION

Therefore, an object of the present invention is to provide a gas concentration measuring method, program, and apparatus in measurement of the concentration of a gas to be measured included in a sample gas that can confirm whether or not the measured value is obtained by measuring an interference-component gas.

The gas concentration measuring method according to the present invention specifies types of a gas to be measured included in a sample gas and an interference-component gas, and wave number regions of measurement of the gas to be measured and the interference-component gas. In the wave number region of measurement of the gas to be measured, an absorbance of the gas to be measured is found to calculate a concentration thereof, and the concentration of the gas to be measured is compared with a first threshold value. When the concentration of the gas to be measured exceeds the first threshold value, an absorbance of the interference-component gas is found to calculate a concentration thereof in the wave number region of measurement of the interference-component gas. The concentration of the interference-component gas is compared with a second threshold value to generate information indicating that the concentration of the gas to be measured is high when the concentration of the interference-component gas is within the second threshold value.

The “first threshold value” is referred to as a “gas-to-be-measured concentration threshold value” in an embodiment, and is a concentration at which “information indicating that the concentration of the gas to be measured is high” is judged to be appropriately generated if the gas to be measured exists at a concentration that is not less than the first threshold value. The “second threshold value” is referred to as an “interference-component gas concentration threshold value” in the embodiment, and is a concentration at which the concentration of the gas to be measured is empirically judged to cause erroneous detection if the interference-component gas exists at a concentration that is not less than the second threshold value.

According to the gas concentration measuring method, when the concentration of the gas to be measured exceeds the first threshold value, in order to judge whether this is caused by the gas to be measured or the interference-component gas by finding the absorbance of the interference-component gas, the absorbance of the interference-component gas is found in the wave number region of measurement of the interference-component gas to calculate the concentration thereof to compare with the second threshold value. If the concentration of the interference-component gas is within the second threshold value, the concentration of the gas to be measured is judged to be high to generate information indicating that the concentration of the gas to be measured is high.

Accordingly, when the concentration of the gas to be measured exceeds the first threshold value, therefore, automatic confirmation is possible whether this is caused by the gas to be measured or the interference-component gas.

If the concentration of the interference-component gas exceeds the second threshold value, it is desirable that the wave number region of measurement of the gas to be measured is changed to carry out the procedure for calculating the concentration of the gas to be measured again. There are generally a plurality of wave number regions of measurement that can be used for quantifying the gas to be measured. Therefore, incomplete detection of the gas to be measured can be prevented by changing the wave number region of measurement thereof to calculate the concentration thereof again.

Note that when an unknown compound is produced in the interference-component gas, the concentration of the interference-component gas cannot be measured.

Therefore, the gas concentration measuring method according to the present invention may be a method for further finding an absorbance of the sample gas in a wave number region of measurement excluding the wave number region of measurement of the gas to be measured (referred to as “unknown compound absorbance” in the embodiment), comparing the absorbance of the sample gas with a third threshold value (referred to as an “unknown compound absorbance threshold value” in the embodiment), and generating information indicating that the absorbance of the unknown compound is high when the absorbance exceeds the third threshold value.

According to this method, the unknown compound can be recognized in addition to quantitative analysis of the gas to be measured. When the absorbance of the unknown compound is high, the information indicating that the absorbance of the unknown compound is high can be generated during operation.

Furthermore, the gas concentration measuring program and the gas concentration measuring apparatus according to the present invention are provided according to substantially the same invention as the gas concentration measuring method provided according to the present invention.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a diagram showing a measuring system for measuring the absorbance of a gas to be measured;

FIG. 2 is a graph showing an overlap between the respective absorption spectra in a predetermined wave number region of a C₅F₈ gas serving as a gas to be measured and a Galden® serving as an interference-component gas;

FIG. 3 is a flow chart showing the procedure for carrying out a gas concentration measuring method according to the present invention;

FIG. 4 is a flow chart showing the procedure for detecting the existence of an unknown compound; and

FIG. 5 is a diagram showing the relationship between ranges a, b, and c in which the respective spectra of gases to be measured exist and a range u in which the spectrum of an unknown compound exists.

### DETAILED DESCRIPTION OF PREFERRED EMBODIMENTS

An embodiment of the present invention will be described with reference to the attached drawings.

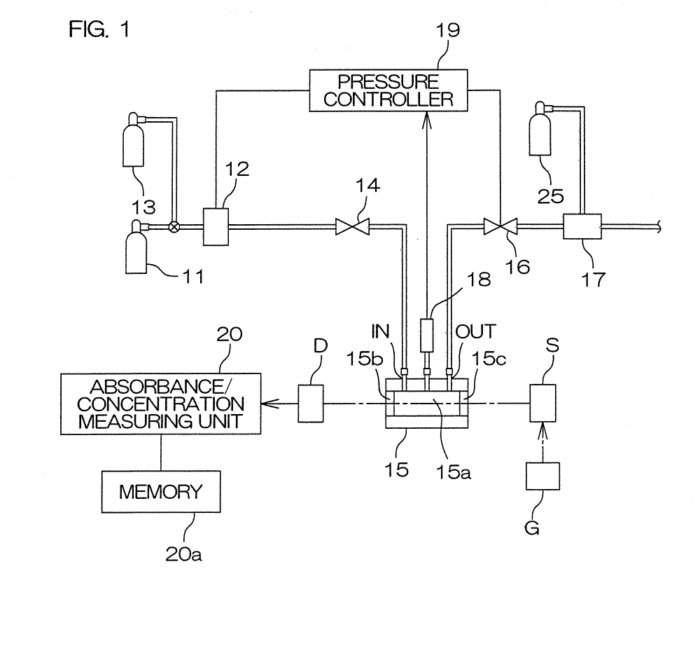

FIG. 1 is a diagram showing a measuring system for measuring a gas to be measured.

In FIG. 1, a sample gas cylinder 11 containing a sample gas and a gas cylinder 13 containing a background gas are set in a gas inlet IN of a gas cell 15 through a mass flow controller 12 for adjusting a gas flow rate and an opening/closing valve 14. The sample gas cylinder 11 and the gas cylinder 13 are switched by a valve mounted on each of the gas cylinders 11 and 13.

On the other hand, an adjusting valve 16 and a vacuum generator 17 (which may be a pressure ejector) for creating negative pressure are connected to a gas output OUT of the gas cell 15. A high-pressure gas cylinder 25 for air, nitrogen, or the like is connected to the vacuum generator 17.

The gas cell 15 includes a cylindrical cell chamber 15a having a predetermined volume and light transmission windows 15b and 15c provided on both end surfaces of the cell chamber 15a, as shown in FIG. 1. The cell chamber 15a is provided with the gas inlet IN and the gas outlet OUT, and is further provided with a port connected to a pressure transducer 18 for measuring pressure in the cell chamber 15a.

Respective control lines of the mass flow controller 12, the adjusting valve 16, and a pressure transducer 18 are connected to a pressure controller 19. The pressure controller 19 adjusts the respective flow rates of the sample gas and the background gas and the opening/closing degree of the adjusting valve 16 on the basis of a pressure measured value of the pressure transducer 18 to keep the inside of the gas cell 15 at predetermined pressure.

The light transmission windows 15b and 15c are made of a material that transmits infrared rays. The material is selected from zinc selenide (ZnSe), calcium difluoride (CaF₂), and barium difluoride (BaF₂).

The gas cell 15 is surrounded by a heat insulating material such as expanded polystyrene such that it is easily kept at a predetermined temperature. The whole gas cell 15, together with an infrared light source G, a spectrometer S, and an infrared detector D, is accommodated in a heat insulating container (not shown). The inside of the heat insulating container is kept at a predetermined temperature by a heater or a Peltier device.

An infrared rays generating system, i.e. an infrared light source G in the diagram, may be any system, and can employ a ceramics heater (surface temperature of 450° C.), for example. A rotating chopper for intercepting and passing light generated in the infrared light source G may be added.

Furthermore, a spectrometer S for selecting the wavelength of infrared rays is provided. The spectrometer S can employ any configuration, such as a spectrometer using a concave diffraction grating.

Light that is irradiated from the infrared light source G passes through the spectrometer S, and enters the gas cell 15 through the light transmission window 15c is emitted from the gas cell 15 through the light transmission window 15b, and is detected by the infrared detector D. The infrared detector D includes a DtGs detector (deuterated triglycine sulfate detector), an InAs detector, a CCD (Charge Coupled Device), or the like.

A detection signal of the infrared detector D is analyzed by an absorbance/concentration measuring unit 20. Such an analyzing method will be described later.

A processing function of the pressure controller 19 and the absorbance/concentration measuring unit 20 is realized by a personal computer executing a program recorded on a predetermined medium such as a CD-ROM or a hard disk. A memory 20a connected to the absorbance/concentration measuring unit 20 is realized by a writable/readable file created within a recording medium such as a hard disk.

In the foregoing measuring system, the sample gas and the background gas that are stored in the gas cylinders 11 and 13 respectively are introduced into the gas cell 15. Pressure in the gas cell 15 is measured with the pressure transducer 18. The pressure controller 19 controls the mass flow controller 12 and the adjusting valve 16 such that a pressure measured value becomes a target value. Such feedback control finally maintains a desired and predetermined pressure inside of the gas cell 15.

In this state, light is irradiated from the infrared light source G to operate the spectrometer S for spectral scanning. The infrared detector D reads the intensity of the light that has passed through the gas cell 15. In such a way, the light intensities of the respective spectra of the sample gas and the background gas with which the gas cell 15 is filled can be measured.

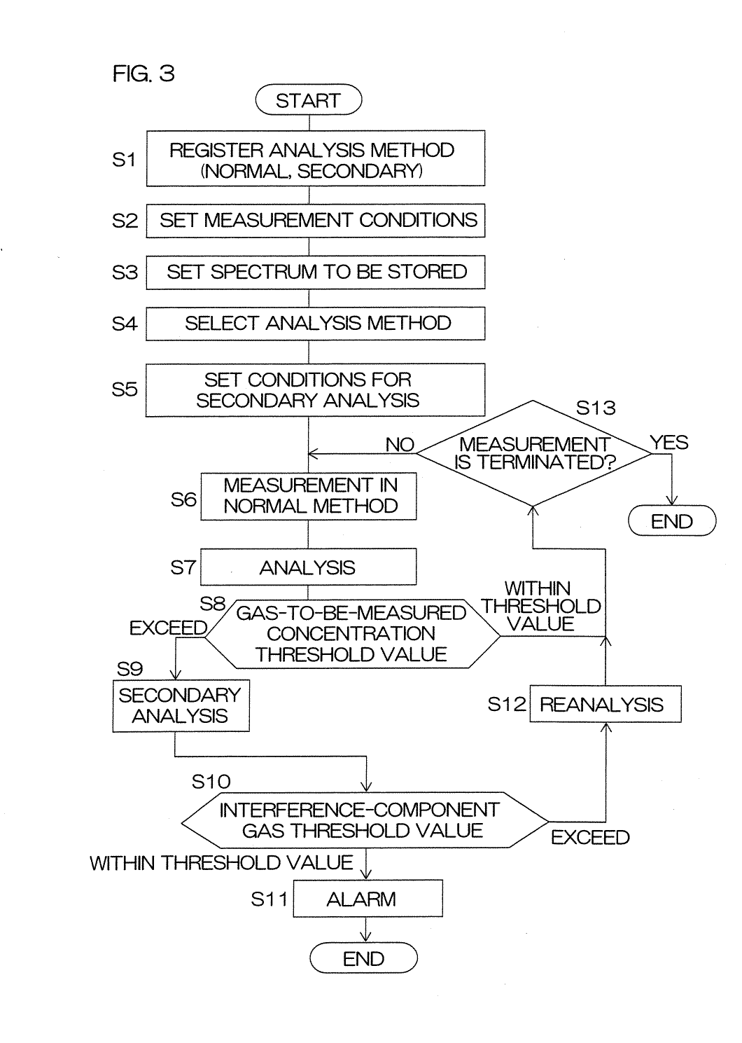

In the gas concentration measuring method according to the present invention, data processing is performed in the absorbance/concentration measuring unit 20 in accordance with the procedure shown in FIG. 3 described below. A component gas to be quantified (hereinafter referred to as a gas to be measured) included in the sample gas and a gas causing erroneous detection (hereinafter referred to as an interference-component gas) because the spectrum thereof is overlapped with that of the gas to be measured. Note that the embodiment in a case where the interference-component gas is not specified will be described later.

Although in the present embodiment, a C₅F₈ (Octafluorocyclopentene) gas is selected as the gas to be measured, and a Galden® (fluorocarbon cleaning agent) is selected as the interference-component gas, the present embodiment is not limited to the same. Examples of the gas to be measured other than C₅F₈ include COF₂ (Carbonyl Fluoride), CH₂F₂ (Difluoromethane), C₄F₆ (Hexafluoro-1,3-butadiene), NF₃ (Nitrogen Trifluoride), and CH₃F (Fluoromethane), which are all poison gases. Examples of the interference-component gas other than the Galden® include HT200 and highfc40, which are both fluorocarbon cleaning agents. Wave number regions used for quantifying the individual gases are shown in Table 1. The unit of a wave number is cm⁻¹.

TABLE 1
Gas to be measured

| | |
|---|---|
| COF₂ | 964.62-1106.7 |
| CH₂F₂ | 1034-1184 |
| C₄F₆ | 943.3-994.1 |
| C₅F₈ | 963.2-1040.8 |
| NF₃ | 858-955 |
| CH₃F | 964.62-1106.7 |

Interference-component gas

| | |
|---|---|
| Galden ® | 796.5-1017.7 |
| HT200 | 1069-1379 |
| Highfc40 | 1095.9-1399.4 |

As can be seen from Table 1, there is an overlap between the respective spectra of the gas to be measured and the interference-component gas. Even if the concentration of the gas to be measured is measured, therefore, it may not find whether the measured concentration is of the gas to be measured or the interference-component gas.

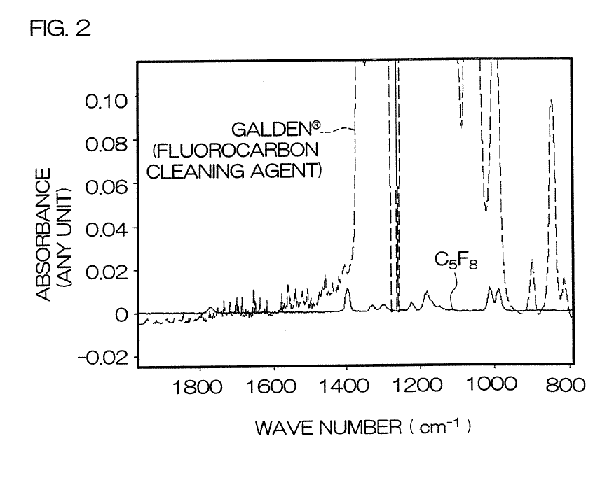

FIG. 2 is a graph showing the respective absorption spectra in a predetermined wave number region of a C₅F₈ gas serving as the gas to be measured and a Galden® serving as the interference-component gas, and indicates that the spectrum of the C₅F₈ gas is buried in the spectrum of the Galden®.

Referring to FIG. 3, a user first creates an analysis method for quantifying a gas concentration and registers the analysis method in the memory 20a (step S1). The analysis method is created for each of the gas to be measured and the interference-component gas. The analysis method created for the gas to be measured is referred to as a normal method, and the analysis method created for the interference-component gas is referred to as a secondary method.

The normal method has a description of the type of the gas to be measured, a method for measuring a wave number region including a peak of absorption of the gas to be measured (if a plurality of wave number regions exist, the plurality of wave number regions are selected from a range of 700 cm⁻¹ to 4500 cm⁻¹, for example, and registered), and the absorbance of the gas to be measured (hereinafter referred to as normal absorbance) to find the concentration thereof. The secondary method has a description of a method for measuring the type of the interference-component gas, a wave number region of the interference-component gas, and the absorbance of the interference-component gas (hereinafter referred to as secondary absorbance) to find the concentration thereof. When each of the analysis methods is registered, calibration curve data relating to a gas having a known concentration is also set and registered.

Measurement conditions are then set (step S2). The measurement conditions include resolution and a wave number region of measurement. The resolution is selected from a range of 0.5 cm⁻¹ to 2 cm⁻¹, for example. The wave number region of measurement is selected from the above-mentioned registered wave number regions. In order to improve measurement sensitivity, however, the wave number regions are selected in descending order of peaks included therein.

A spectrum to be stored is then set (step S3). The spectrum to be stored is selected from the normal absorbance and the secondary absorbance.

The analysis method is then selected (step S4). For example, C₅F₈ is selected as the gas to be measured, and a Galden® is selected as the interference-component gas. Thus, the gas to be measured and the analysis method therefor and the interference-component gas and the analysis method therefor are specified.

Conditions for the secondary analysis of the interference-component gas are then set (step S5). The conditions include a calibration curve and a wave number region of measurement of the interference-component gas, and a threshold value of the concentration of the interference-component gas. Here, the “interference-component gas concentration threshold value” means a concentration at which the gas to be measured is empirically judged to cause erroneous detection (that the concentration of the gas to be measured is erroneously detected high, although it is actually low) if the interference-component gas exists at a concentration that is not less than the interference-component gas concentration threshold value.

The lower the “interference-component gas concentration threshold value” is set, the lower the probability that the concentration of the gas to be measured is erroneously detected becomes. However, the probability of reanalysis (step S12) increases, so that it takes long until the measurement is completed. On the other hand, the higher the “interference-component gas concentration threshold value” is set, the lower the probability of reanalysis becomes. However, the probability that the concentration of the gas to be measured is erroneously detected by the interference-component gas increases, so that it is desirable that the “interference-component gas concentration threshold value” is determined in consideration of both the frequency of erroneous detection by the interference-component gas and the working efficiency of detection of the gas to be measured.

The procedure for measurement in the normal method is then started. The measurement is made in accordance with a selected analysis method over a background gas (e.g., a nitrogen gas) that is introduced into the gas cell 15 from the gas cylinder 13 and a gas to be measured that is collected in the sample gas cylinder 11 and is introduced into the gas cell 15 as objects (Step S6). In such a measuring method, the gas cell 15 is first filled with the background gas, the spectrum of light transmitted by the background gas is acquired in a wave number region of measurement of C₅F₈ serving as the gas to be measured, and an integration value B of the amount of the light in the wave number region of measurement is found. Then, the background gas in the gas cell 15 is replaced with a sample gas, the spectrum of light transmitted by the gas to be measured is acquired, and an integration value S of the amount of the light in the wave number region of measurement is found.

In the procedure for analysis (step S7), the absorbance Abs(S) of the gas to be measured is found using the amount B of the transmitted light by the background gas and the amount S of the transmitted light by the gas to be measured by the following equation:

Abs(S)=−log(S/B)

The concentration of the gas to be measured is found using a calibration curve for defining the relationship between the absorbance and concentrations.

The found concentration of the gas to be measured is then compared with a threshold value of the concentration of the gas to be measured (step S8) to determine whether or not the concentration of the gas to be measured exceeds the threshold value of the concentration of the gas to be measured. Here, the “gas-to-be-measured concentration threshold value” means a concentration at which an abnormality is judged to arise if the gas to be measured exists at a concentration that is not less than the gas-to-be-measured concentration threshold value. When the concentration of the gas to be measured does not exceed the gas-to-be-measured concentration threshold value, the procedure proceeds to step S13 to continue the measurement. When the concentration of the gas to be measured exceeds the gas-to-be-measured concentration threshold value, the gas to be measured is detected at a concentration exceeding a concentration at which the gas to be measured is normally detected, so that the procedure proceeds to step S9.

In step S9, the secondary analysis over the interference-component gas as an object is performed. That is, the absorbance Abs (S₁) of the interference-component gas is found using an integration value S₁ of the amount of light in the wave number region of measurement and the amount B of transmitted light by the background gas on the basis of the spectrum of light transmitted by the interference-component gas by the following equation:

Abs(S₁)=−log(S₁/B)

The concentration of the interference-component gas is found using a calibration curve for defining the relationship between the absorbance Abs (S₁) and concentrations.

The found concentration of the interference-component gas is then compared with the interference-component gas concentration threshold value (step S10) to determine whether or not the concentration of the interference-component gas exceeds the interference-component gas concentration threshold value.

When the concentration of the interference-component gas exceeds the interference-component gas concentration threshold value, judgment whether or not the concentration of the gas to be measured is abnormal is held to start the procedure for reanalysis (step S12). In the procedure for reanalysis, the gas to be measured is examined again. At this time, it is desirable that the wave number region of measurement is changed into the wave number region including the second highest peak out of the above-mentioned registered wave number regions. As in the foregoing steps S6 and S7, the absorbance and the concentration of the gas to be measured are found, and the found concentration is compared with the gas-to-be-measured concentration threshold value. At this time, it is desirable that the gas-to-be-measured concentration threshold value is also lowered than before (measurement sensitivity is increased). Accordingly, the concentration abnormality of the gas to be measured can be further verified by thus increasing the measurement sensitivity as well as changing the peak of the infrared spectrum of the normally used gas to be measured into a different peak.

When the concentration of the interference-component gas is within the interference-component gas concentration threshold value in step S10, a large concentration value is of the gas to be measured. Therefore, an alarm is generated to transmit an alarm signal to a control panel (step S11).

When a concentration abnormality of the gas to be measured is thus detected, automatic confirmation is possible whether the abnormality is caused by the gas to be measured or the interference-component gas.

The embodiment in a case where the interference-component gas is not specified will be then described. In this procedure, when a spectrum appears in a wave number region of measurement other than the wave number region of measurement of the gas to be measured, an unknown compound is considered to be detected to generate an alarm.

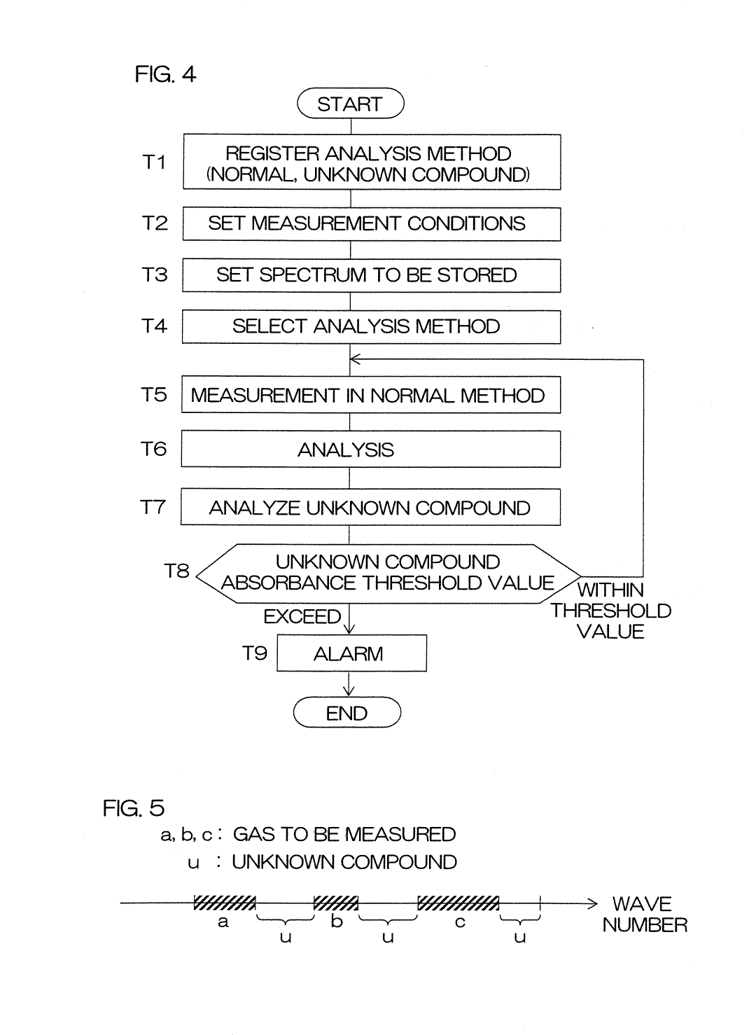

FIG. 4 is a flow chart showing the procedure for analysis processing of the unknown compound.

First, an analysis method for quantifying a gas concentration is created and registered (step T1). The analysis method is created for each of the gas to be measured and the unknown compound. That is, the analysis method has a description of a method for measuring a wave number region of the gas to be measured and the normal absorbance to find the concentration of the gas to be measured. Further, a wave number region of the unknown compound (region that is not overlapped with the wave number region of the gas to be measured) and a threshold of the absorbance in the wave number region (hereinafter referred to as unknown compound absorbance) are registered as an “unknown compound absorbance threshold value. The unknown compound absorbance threshold value means a threshold value to be compared with the absorbance of a sample gas that is found in a wave number region of measurement excluding the wave number region of measurement of the gas to be measured when the unknown compound is produced in the interference-component gas. When the absorbance of the sample gas exceeds the “unknown compound absorbance threshold value”, an unknown compound is considered to exist. When the absorbance of the sample gas does not exceed the “unknown compound absorbance threshold value”, no unknown compound is considered to exist.

When an analysis method for the gas to be measured is registered, a calibration curve for a gas having a known concentration is also set and registered. The calibration curve for the unknown compound cannot be registered because it is not clear.

Measurement conditions are then set (step T2). The measurement conditions include resolution and a wave number region of measurement. The resolution is selected from a range of 0.5 cm⁻¹ to 2 cm⁻¹, for example, and the wave number region of measurement is selected from the registered wave number regions. In order to improve measurement sensitivity, therefore, the wave number regions are selected in descending order of peaks included therein.

If there are three types of gases to be measured (ranges in which their spectra exist are respectively taken as a, b, and c), for example, the ranges, i.e., the wave number regions a, b, and c are selected in descending order of peaks included in the regions. In addition, a wave number region u excluding the wave number regions a, b, and c is also selected.

A spectrum to be stored is then set (step T3). The spectrum to be stored is selected from the normal absorbance and the unknown compound absorbance.

An analysis method is then selected (step T4). C₅F₈, for example, is selected as the gas to be measured. Thus, the gas to be measured and the wave number region of measurement thereof are specified.

The procedure for measurement in a normal method is then started. The measurement is made in accordance with the selected analysis method over the collected sample gas as an object (step T5). In the measurement, the spectrum of light transmitted by a nitrogen gas serving as a background gas in a wave number region of measurement of C₅F₈ is acquired to find an integration value B of the amount of the light in the wave number region. Then, the spectrum of light transmitted by the gas to be measured is acquired to find an integration value S of the amount of the light in the wave number region.

In the procedure for analysis (step T6), the absorbance of the gas to be measured is found using the amount B of the transmitted light by the background gas and the amount S of the transmitted light by the gas to be measured. The concentration of the gas to be measured is found using a calibration curve for defining the relationship between the absorbance and concentrations.

Unknown compound analysis over an unknown compound as an object is performed (step T7). That is, an integration value S₂ of the amount of light in the wave number region u registered in an unknown compound method is found on the basis of a spectrum in the wave number region u to find the absorbance Abs (S₂) of the unknown compound using the amount B of the transmitted light by the background gas by the following equation:

Abs(S₂)=−log(S₂/B)

When the absorbance Abs (S₂) of the unknown compound exceeds the unknown compound absorbance threshold value, the absorbance of the unknown compound is determined to be high (step T8).

When the absorbance of the unknown compound is determined to be high, an alarm is generated to transmit the alarm to the control panel (step T9). When the absorbance Abs (S₂) of the unknown compound does not exceed the unknown compound absorbance threshold value, the measurement is continued.

In such a way, when the absorbance of the unknown compound is higher than the unknown compound absorbance threshold value, the concentration of the unknown compound can also be presumed high to generate information indicating that the concentration of the unknown compound is high during operation and inform a manager of the information.

The present invention is applicable to gas leak detection in a gas production line, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

The present application corresponds to Japanese Patent Application No. 2007-066854 filed with Japanese Patent Office on Mar. 15, 2007 and the whole disclosure thereof is incorporated herein by reference.

What is claimed is:

1. A method for measuring a concentration of a gas to be measured included in a sample gas, comprising the steps of:
a. specifying a type of the gas to be measured included in the sample gas, a wave number region of measurement of the gas to be measured, a type of an interference-component gas whose wave number region of measurement is at least partially overlapped with the wave number region of measurement of the gas to be measured, and a wave number region of measurement of the interference-component gas;
b. finding an absorbance of the sample gas to calculate the concentration of the gas to be measured in the wave number region of measurement of the gas to be measured;
c. comparing the concentration of the gas to be measured with a first threshold value;
d. finding an absorbance of the sample gas to calculate a concentration of the interference-component gas in the wave number region of measurement of the interference-component gas when the concentration of the gas to be measured exceeds the first threshold value;
e. comparing the concentration of the interference-component gas with a second threshold value;
f. generating information indicating that the concentration of the gas to be measured is high when the concentration of the interference-component gas is within the second threshold value.

2. The method according to claim 1, wherein the “first threshold value” is a concentration at which the “information indicating that the concentration of the gas to be measured is high” is judged to be appropriately generated if the gas to be measured exists at a concentration that is not less than the first threshold value.

3. The method according to claim 1, wherein the “second threshold value” is a concentration at which the concentration of the gas to be measured is judged to be erroneously detected if the interference-component gas exists at a concentration that is not less than the second threshold value.

4. The method according to claim 1, wherein the wave number region of measurement of the gas to be measured is changed to carry out the procedure for calculating the concentration of the gas to be measured again when the concentration of the interference-component gas exceeds the second threshold value in the foregoing procedure e.

5. The method according to claim 1, further comprising the steps of
finding an absorbance of the sample gas in a wave number region of measurement excluding the wave number region of measurement of the gas to be measured, and
comparing the absorbance of the sample gas with a third threshold value to generate information indicating that an unknown compound exists and an absorbance thereof is high when the absorbance exceeds the third threshold value.

6. A program loaded into a computer for measuring a concentration of a gas to be measured included in a sample gas, comprising the steps of:
registering a type of the gas to be measured included in the sample gas, a wave number region of measurement of the gas to be measured, a type of an interference-component gas whose wave number region of measurement is at least partially overlapped with the wave number region of measurement of the gas to be measured, and a wave number region of measurement of the interference-component gas;
calculating the concentration of the gas to be measured on the basis of absorbance data relating to the sample gas in the wave number region of measurement of the gas to be measured;
comparing the concentration of the gas to be measured with a first threshold value to calculate a concentration of the interference-component gas on the basis of absorbance data relating to the sample gas in the wave number region of measurement of the interference-component gas when the concentration of the gas to be measured exceeds the first threshold value; and
comparing the concentration of the interference-component gas with a second threshold value to generate information indicating that the concentration of the gas to be measured is high when the concentration of the interference-component gas is within the second threshold value.

7. A gas concentration measuring apparatus for measuring a concentration of a gas to be measured that is included in a sample gas using a function of a computer, comprising:
a unit arranged to register a type of the gas to be measured included in the sample gas, a wave number region of measurement of the gas to be measured, a type of an interference-component gas whose wave number region of measurement is at least partially overlapped with the wave number region of measurement of the gas to be measured, and a wave number region of measurement of the interference-component gas;
a unit arranged to calculate the concentration of the gas to be measured on the basis of absorbance data relating to the sample gas in the wave number region of measurement of the gas to be measured;
a unit arranged to compare the concentration of the gas to be measured with a first threshold value to calculate a concentration of the interference-component gas on the basis of absorbance data relating to the sample gas in the wave number region of measurement of the interference-component gas when the concentration of the gas to be measured exceeds the first threshold value; and
a unit arranged to compare the concentration of the interference-component gas with a second threshold value to generate information indicating that the concentration of the gas to be measured is high when the concentration of the interference-component gas is within the second threshold value.
